(19) United States
(12) Patent Application Publication
(10) Pub. No.: US 2017/0243152 A1
(43) Pub. Date: Aug. 24, 2017

(54) A STAFF ROSTERING SYSTEM

(71) Applicant: MARANTH PTY LTD, Victoria (AU)

(72) Inventors: Stephen John THOMSON, Victoria (AU); Sachin NISCHAL, Victoria (AU)

(21) Appl. No.: 15/507,422

(22) PCT Filed: Aug. 31, 2015
(86) PCT No.: PCT/AU2015/050509

§ 371 Date: Feb. 28, 2017

(30) Foreign Application Priority Data
Aug. 29, 2014 (AU) 2014903431

(51) Int. Cl. G06Q 10/06

(52) U.S. Cl. CPC G06Q 10/063116

(57) ABSTRACT

A staff roster allocation system relies on apps both to allow the client to register the need for a shift at a certain location and on a staff member to accept a shift at a specified location. The client may tentatively allocate available staff members to a certain shift for acceptance or rejection by the staff member, or the staff members may be advised when shift are available or may query for possible shifts. Where the app is running on a staff member phone the allocation of a staff member to a shift may be rapid.

### TECHNICAL FIELD

The invention generally relates to a staff allocation and rostering system.

More particularly the invention relates to staff rostering systems in which confirmation of allocation is accelerated.

### GLOSSARY

A “shift allotment” is a single period at a specific location over which one person may work.

A “shift” is a single term of work over a shift allotment by a person.

A “double shift” is two consecutive shift allotments at a specific location worked by a person.

A “staff member” is a person with required qualifications who has provided to the system details sufficient to be available for a roster.

A “roster” is a list of shift allotments which shift allotments can be allocated to staff members.

### BACKGROUND ART

Staff rostering systems are well known for use in industries in which it is critical that a certain position must be manned at specific times, or in which 24 hour personnel cover is required, or in which a person to carry out a job requiring certain skills is required for spot cover in some location.

Typically a rostering system relies on someone in charge of rostering who contacts a person they think should be rostered on for a particular timeslot in a particular position at a particular location and awaits their confirmation or advice that they are available/not available. Once a person is confirmed or otherwise in a slot the onwards construction of the roster can proceed. This tends to slow down the process of creating a roster because the roster cannot be confirmed until all the required timeslots are filled with people who have the skills to do the required job and who have agreed they are available.

This proves even more of a problem with jobs which are allocated on a short time frame, for instance elderly care jobs for individuals who sometimes require a qualified carer, but are normally taken care of by a caregiver living with them. Typically the roster for an organisation providing carers to fill these occasional jobs requires an organiser to contact various potential carers until they can locate someone who is prepared to take a care position for the required time at the desired location. This can usually take some time, and the client may end up being cared for by someone they would prefer not to have.

The present invention provides a solution to this and other problems which offers advantages over the prior art or which will at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in Australia or in any other country.

### SUMMARY OF THE INVENTION

In one exemplification the invention relates to a staff rostering system having multiple disseminated instances of a client interface and multiple disseminated instances of a staff interface, a booking engine interacting with the client and staff interfaces, a reporting engine interacting with the client and staff interfaces and data storage wherein:

the booking engine receiving from a client interface a declaration of at least one shift at one location for at least one shift allotment requiring at least one staff member, the shift details being stored in the data storage;

the staff interface allowing a potential staff member to provide details including qualifications relevant to a shift for storage in the data storage;

the reporting engine providing from data storage a report via the staff interface of available shifts to those staff members who are suitably qualified for the available shifts and who are potentially available for allocation to a shift;

the staff interface providing a staff member viewing the report the ability to allocate themselves to a shift or to confirm an allocation to a shift.

Preferably a client may tentatively select at least one staff member who is suitably qualified and who is potentially available but who is not yet allocated to a shift at that shift allotment.

Preferably staff members may allocate themselves to a shift allotment.

These and other features of as well as advantages which characterise the present invention will be apparent upon reading of the following detailed description and review of the associated drawings.

### BRIEF DESCRIPTION OF THE DRAWINGS

FIG. 1 is a diagram of the dataflow relating to the staff member allocation process.

FIG. 2 is a process diagram of the actions taken by a client requiring staff and by the staff members themselves.

### DESCRIPTION OF THE INVENTION

Many jobs are required to be allocated in shifts, some of these being related for instance to the health care, transport, utilities and hospitality industries. Normally shifts are allocated by negotiation between the employees and the employers, or their representatives, but where the staff involved are numerous (a hospital, an airline, a cities bus services) the number of interactions involved require something more automated.

Usually the automation consists of little more than a series of emails or phone calls as the employers representative and the employee come to an agreement about who will do what. Even the largest of organisations provide only a web interface to a rostering system, and negotiation between employers representatives and the actual staff members are normally negotiated item by item.

The current invention proposes a more disseminated system in which the jobs required to be done are made available as shift allotments to a personal app available to staff members, and staff members can opt to confirm their acceptance of a particular shift. To further reduce the system loads the creation of the shift allotments can be carried out by the person or section who wants those shift allotment slots covered by one of the staff, and the requirements for the person for the shift allotment can be part of the shift allotment slot specification. Because the system can similarly hold the qualifications of the staff members it can be arranged that only a staff member with the required qualifications will see the shift allotments available when querying them with a personal app.

In this way the system can cater for such things as a healthcare service providing assistant home care for an elderly person where a caregiver must be absent. All that is required is that the assessor who assesses the level of healthcare required lodges a shift request for one or more shift allotments, again via a personal app, for a particular location with a required set of skills and qualifications. From the staff members available and reviewing the available shift allotments as many as are required can accept the shift and fill the allotment. The allotment details may include details of the elderly persons name, location and care requirements.

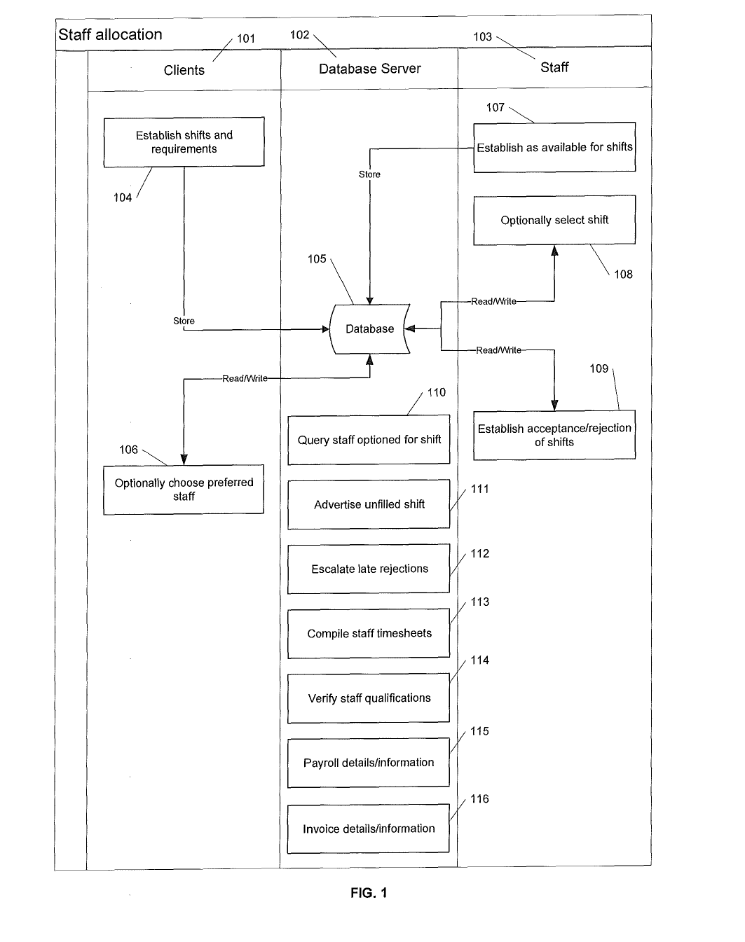

Referring now to FIG. 1 the drawing shows the connections between the parties involved in the system. Clients 101 are provided with an application which allows them to establish at 104 details of which shift allotments are required and what qualifications or experience are required of the person or persons filling those allotments. This information is transferred to database 105 at a database server 102 so that the information is available to the staff members available to take the shift covering that allotment. The client may also, at 106, view the staff who have made themselves available for shifts in a particular shift allotment and may tentatively choose one or more of these.

Staff members 103 may also connect at 107 to the database server 102 to establish their availability for various shift allotments in general. This may include making themselves unconditionally available for any shift allotments, making themselves unconditionally available for shift allotments at a particular location, making themselves conditionally available for any shift allotments or for shift allotments at a particular location, making themselves unavailable for a shift, making themselves unavailable for a day. They may also, at 108, view the individual shift allotments and confirm themselves as accepting being rostered for an available shift allotment, in which case they will be allocated to the shift allotment. Optionally if they are selected for a shift allotment where they are conditionally available at 109, either by the system or from a tentative choice by a client, as at 106, they may accept or reject that selection.

The database server in addition to the storage functions also carries out various housework functions. These may include at 110 sending a query as to shift availability at a particular location to staff members who have already indicated they are available for a shift allotment but have not selected a particular allotment; at 111 advertising a shift allotment which has not yet been filled and which has no staff candidates to staff members who have not yet indicated they are unavailable for that particular shift allotment; at 112 escalating a shift which has received a late rejection by a staff member; at 113 compiling staff timesheets from the data for shifts worked provided by the system, by staff members and by clients, and verifying at 114 that staff members have entered acceptable qualifications on the staff member profile.

Other functions of the database server may include holding at 115 details and information for the staff members payroll, and at 116 client details and information for invoicing the clients.

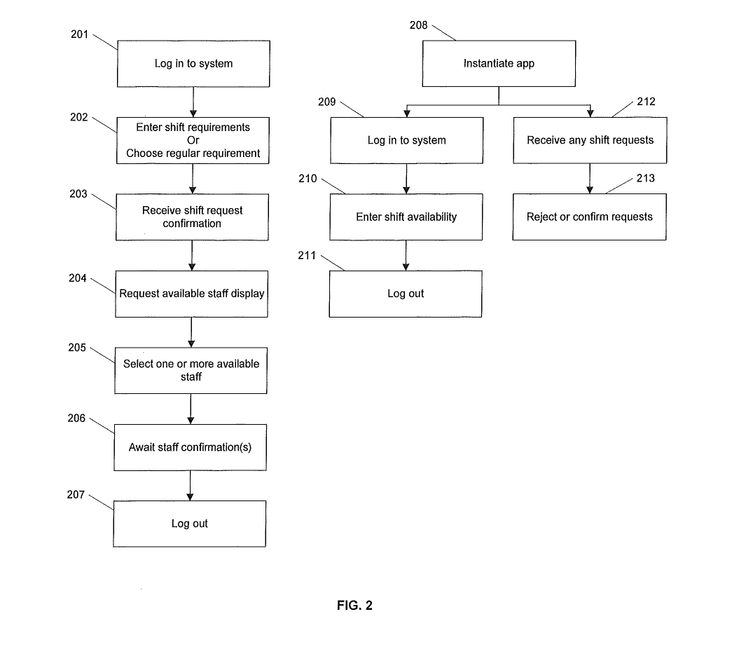

FIG. 2 shows at 201 the process step of a client logging in to the system. At 202 the client either enters the shift requirements or, if this is a template shift already in the system, chooses a template shift as a regular requirement.

At 203 the client receives confirmation of the shift request and at 204 may request a display of the staff who have made themselves available for a shift or who are possibly available for a shift at the client location. The client may select one or more of the available staff for the shift. Staff members who have unconditionally made themselves available (i.e. are on standby awaiting a shift) will be allocated immediately, staff who are possibly available will be queried if the shift is not already allocated.

The client may then await at 206 the confirmations from staff, both immediate and delayed as staff possibly available respond.

At 208 a staff member instantiates the app on their phone and at 209 logs in to the system. They may enter their availability at 210 for the various shifts available at the various locations before logging out at 211.

The app may meanwhile receive any shift requests at 212 and these may be rejected or confirmed at 213 unless the staff member had unconditionally made themself available, when confirmation is automatic.

Staff qualifications, expertise and experience are preferably stored in the system as codes which are currently used in the industry concerned, and are available from the system to assist clients in setting the qualification and experience criteria. This allows the system to present only the names of available suitably qualified staff members to a client, and ensures that a staff member cannot choose to staff a shift allotment which has criteria not met by the staff members qualifications.

A client, when requesting staffing of a shift allotment, may specify the period of the shift allotment. While it is normal to have shift allotments of perhaps 8 hours, forming a Morning, an Afternoon and a Night shift it may be that shifts of less than this figure or more than this figure may be required depending on the reason for the allotment, the regulations governing the industry concerned, or the availability of staff for the hours required.

A client may specify the location of the shift allotment. While most allotments may be at a normal place of work, such as a hospital, it may be that a suitably qualified person is required for a temporary shift at a nursing home. Preferably the system is location sensitive so that it will preferentially advise staff members in the locality of the shift allotment, of the requirement before advising others. The system may also provide geo-location data to the staff member accepting such a shift.

Where the shift allotment is related to a healthcare service or high-contact public service the client may specify the potential infection status of a shift allotment. For instance the selected staff member may not have been at a facility infected with a norovirus for at least 48 hours prior to the shift allotment.

A client, having created a shift allotment, may choose from those staff members who have already indicated that they are available for a shift but who are not yet confirmed in a shift allotment. The client may prioritise the order of choice. The staff member will be advised of the choice on next viewing of the app and may accept or reject it as desired.

Staff members may choose to make themselves available for a particular shift allotment, may choose to make themselves generally available for any suitable shift allotments, may choose to take no action and be prompted by a general broadcast offering of an available shift allotment, may opt to mark themselves as unavailable for one or several shift allotments. These choices cover a general spectrum from proactive to reactive, allowing a range of strategies for filling shift allotments. A particular strategy possible is a “Tontine” in which a shift allotment is broadcast to several staff members who progressively decline the shift until it is by default allocated to the last remaining staff member. Other choices for availability may be provided.

Clients creating a shift allotment may be able to view data on the staff member relating to their service at the clients location, for instance the number of shifts the staff member has worked at that location, whether the client disliked that particular staff member and how far from the client location the staff member is normally located.

The staff members may enter various types of shift availability criteria, such as “unconditionally available for any shift”, “available for any shift”, “not available for one shift”, “possibly available”, “can work double shift” or “unavailable for 24 hours”.

It is to be understood that even though numerous characteristics and advantages of the various embodiments of the present invention have been set forth in the foregoing description, together with details of the structure and functioning of various embodiments of the invention, this disclosure is illustrative only, and changes may be made in detail so long as the functioning of the invention is not adversely affected. For example the particular elements of the shift allotment system may vary dependent on the particular application for which it is used without variation in the spirit and scope of the present invention.

In addition, although the preferred embodiments described herein are directed to shift allotments for use in a healthcare system, it will be appreciated by those skilled in the art that variations and modifications are possible within the scope of the appended claims. For instance the system is equally applicable to truck driving in the transport industry and to rostering stewards on an airline.

1. A staff rostering system having multiple disseminated instances of a client interface and multiple disseminated instances of a staff interface, a booking engine interacting with the client and the staff interfaces, a reporting engine interacting with the client and the staff interfaces and a data storage wherein:
the booking engine receiving from a client interface a declaration of at least one shift at one location for at least one shift allotment requiring at least one staff member, the shift details being stored in the data storage;
the staff interface allowing a potential staff member to provide details including qualifications relevant to a shift for storage in the data storage;
the reporting engine providing from the data storage a report via the staff interface of available shifts to those staff members who are suitably qualified for the available shifts and who are potentially available for allocation to a shift allotment;
the staff interface providing a staff member remotely viewing the report the ability to allocate themselves to an available shift allotment or to confirm an allocation to an available shift allotment.

2. A staff rostering system as claimed in claim 1 wherein a client may tentatively select at least one staff member who is suitably qualified for a client shift and who is potentially available but who is not yet allocated to a shift at that shift allotment.

3. A staff rostering system as claimed in claim 1 wherein staff members who are suitably qualified for a shift can allocate themselves to a shift allotment.

4. A staff rostering system as claimed in claim 1 wherein staff members who are suitably qualified for a shift can decline a shift allotment.

5. A method of rostering a staff member to a shift allocation comprising:
providing a staff rostering system having multiple disseminated instances of a client interface and multiple disseminated instances of a staff interface,
providing a booking engine interacting with the client and the staff interfaces,
providing a reporting engine interacting with the client and the staff interfaces and a data storage wherein:
receiving at the booking engine from a client interface a declaration of at least one shift at one location for at least one shift allotment requiring at least one staff member, the shift details being stored in the data storage;
receiving at the staff interface details including qualifications relevant to a shift from a potential staff member for storage in the data storage;
providing from the reporting engine a report available to the staff interface of available shifts and shift allotments to those staff members who are suitably qualified for the available shifts and who are potentially available for allocation to a shift allotment;
providing to a staff member remotely viewing the report the ability to allocate themselves to an available shift allotment or to confirm an allocation to an available shift allotment using the booking engine.

6. A method as claimed in claim 5 wherein the report from the reporting engine of available shifts and shift allotments is disseminated to all those staff members who are suitably qualified and who are potentially available for allocation to an available shift allotment.

7. A method as claimed in claim 6 wherein staff members receiving a disseminated report of an available shift allocation may decline the shift allotment.

8. A method as claimed in claim 7 wherein a staff member receiving a disseminated report of an available shift allocation which has been declined by all other staff members will be allocated the shift allocation.
